(19) United States
(12) Patent Application Publication
(10) Pub. No.: US 2006/0210062 A1
(43) Pub. Date: Sep. 21, 2006

(54) Sanitary covers and articles having same

(76) Inventors: Marc J. DeMichele, Louisville, KY (US); Christopher D. Stockton, Louisville, KY (US); Richard B. Mays, Naples, FL (US); Henry P. Young, Tavernien, FL (US); Donald S. Copland, Brookville, IN (US); John T. Turner, West Chester, OH (US)

Correspondence Address: Mark F. Smith, 905 Ohio Pike, Cincinnati, OH, 45245, US

(21) Appl. No.: 11/357,486

(22) Filed: Feb. 18, 2006

Related U.S. Application Data
(63) Continuation-in-part of application No. 10/368,714, filed on Feb. 18, 2003, now abandoned.
(60) Provisional application No. 60/676,613, filed on Apr. 30, 2005.

(51) Int. Cl. H04M 1/00

(52) U.S. Cl. 379/451

(57) ABSTRACT

A sanitary cover for use in covering a surface area of an article. The sanitary cover comprises a fabric material and means for attaching the sanitary cover to the article. In a preferred embodiment of the invention the fabric material forming the sanitary cover comprises an inner layer formed from a hydrophilic material and an outer layer formed from a hydrophobic material and at least one middle layer effective for reducing the passage of contaminates there through.

### CROSS-REFERENCE TO RELATED APPLICATION

This is a continuation-in-part of U.S. patent application Ser. No. 10/368,714, filed on Feb. 18, 2003, and U.S. Provisional Patent Application No. 60/676,613, filed on Apr. 30, 2005 both of which deal with related subject matter.

### BACKGROUND OF THE INVENTION

This invention relates to sanitary covers and, more particularly, to sanitary covers and articles having such covers.

Devices such as microphones, telephones, earphones, headsets, and the like are typically used by many different people, whether for home or office use. Other articles, such as tools, equipment, tables, doors, carts, computer devices, and the like, have contact surfaces that are also used by various individuals. As a result, the contact surfaces of such devices collect germs, cold viruses, dust, dirt and other contamination which can spread to many users. Some users attempt to eliminate such contamination by spraying the contact pieces with disinfectant or wiping with a damp cloth. For electronic equipment, however, such cleaning methods can cause damage or limit the usefulness of life of the device. In addition, under normal working conditions, the sensitive electronic components of such devices are exposed to ambient conditions, such as moisture from the mouth, spilled fluids, dust, etc.

Accordingly, a need exists for a sanitary cover that can be used with a variety of apparatus that is effective for reducing or preventing the spread of contamination, such as germs, bacteria, viruses, and the like. A need also exists for a sanitary cover that is disposable and effective for reducing or eliminating the risk of damage to electrical devices caused by dust, moisture, liquids, or other such and protects the mouth and earpieces of the audio devices.

### SUMMARY OF THE INVENTION

The present invention is a new and novel sanitary cover that can be used with a variety of apparatus that is effective for reducing or preventing the spread of contamination such as bacteria, virus, dust, dirt, and the like.

In a preferred embodiment of the invention the cover is formed from an elastomeric polymer.

In another preferred embodiment, the cover is formed from a spun lace elastomeric material having a repellent finish.

In another preferred embodiment, the cover is provided with a germicide effective for eliminating or reducing germ accumulation or the migration of germs through the cover.

In another preferred embodiment of the invention, the cover is provided with a bactericide agent that is effective for eliminating or reducing bacterial accumulation or the migration of bacteria through the cover.

In another preferred embodiment of the invention, the cover is provided with an antiviral agent that is effective for eliminating or reducing virus accumulation or the migration of virus through the cover.

In a preferred embodiment of the invention, the sanitary cover comprises a fabric that is substantially acoustically transparent.

In another preferred embodiment of the invention, the cover includes a padded inner layer.

In another preferred embodiment of the invention, the cover is formed from a liquid impermeable fabric.

In another preferred embodiment of the invention, the cover is formed from a fabric that is biodegradable.

In another preferred embodiment of the invention, the cover is formed from a composite of layers forming a labyrinth effective for reducing or eliminating the passage of contamination there through.

In another preferred embodiment of the invention, the sanitary cover comprises a fabric that allows air flow there through.

In another preferred embodiment of the invention, the cover is formed from a fabric treated with a lotion composition.

In another preferred embodiment of the invention, the cover includes a decorative outer cover.

In another preferred embodiment of the invention, the cover includes means for attaching the cover to a device.

In another preferred embodiment of the invention, the attachment means comprises an elastic band or collar.

In another preferred embodiment of the invention, the attachment means comprises static cling material.

In another preferred embodiment of the invention, the attachment means comprises a mechanical attachment means.

In another preferred embodiment of the invention, the attachment means comprises a releasable adhesive.

In another preferred embodiment of the invention, the sanitary cover includes means for indicating the freshness of the cover.

In another preferred embodiment of the invention, the sanitary cover is sized to accommodate different articles.

In another preferred embodiment of the invention, the sanitary cover is shaped to accommodate different articles.

Another preferred embodiment of the invention is a sanitary cover comprises a fabric that is substantially acoustically transparent and effective for eliminating or reducing contamination from migrating through the cover.

Other objects and advantages of the invention will be apparent from the following description, the accompanying, drawings, and the appended claims.

### BRIEF DESCRIPTION OF THE DRAWINGS

To provide a more complete understanding of the present invention and further features and advantages thereof, reference is now made to the following description taken in conjunction with the accompanying drawings, in which:

FIG. 1 is a side perspective view of a preferred embodiment of the sanitary cover of the present invention;

FIG. 2 is a representation of the sanitary cover of the present invention showing the fabric material formed from a plurality of layers;

FIG. 3 is an exploded perspective representation of another preferred embodiment of the invention showing the fabric material formed from a plurality of layers creating a labyrinth effective for reducing or eliminating the passage of contaminates;

FIG. 4 is a perspective view of a pair of sanitary covers having a mechanical attachment means for attaching to a conventional;

FIG. 5 is a perspective view of a sanitary cover of having a mechanical attachment means for attaching to a conventional communication mouthpiece;

FIG. 6 is a perspective view of a convention acoustic headphone showing the sanitary cover of the present invention attached to one of the ear pieces;

FIG. 7 is a perspective view of a convention acoustic headphone showing the sanitary cover of the present invention attached to one of the ear pieces and a second sanitary cover being applied to a second ear piece;

FIG. 8 is a perspective view a conventional handle, such as a shopping cart handle, having the sanitary cover of the present invention applied thereto;

FIG. 9 is a perspective view of a convention handle, such as a door handle;

FIG. 10 is a perspective view of a conventional handle, such as a door handle, as shown in FIG. 9, having the sanitary cover of the present invention applied thereto;

FIG. 11 is a perspective view of another conventional handle having the sanitary cover of the present invention applied thereto;

FIG. 12 is a perspective view of the steering wheel of a conventional motor vehicle showing another embodiment of the sanitary cover of the present invention being applied thereto;

FIG. 13 is a perspective cut-away view of a typical electrical device, such as a conventional computer “mouse,” showing the sanitary cover of the present invention applied thereto;

FIG. 14 is a perspective view of another preferred embodiment of the sanitary cover configured for covering the contact surface for various apparatus such as table tops; and

FIG. 15 is a perspective view of another preferred embodiment of the sanitary cover configured for use as an inner liner for a hat, such as a safety hat, helmet, hard hat, or the like.

### DETAILED DESCRIPTION OF THE PREFERRED EMBODIMENTS OF THE INVENTION

Although the foregoing invention has been described in some detail for purposes of clarity of understandings, it will be apparent that certain changes and modifications may be practiced within the scope of the appended claims. Accordingly, it should be understood that the present disclosure is to be considered as exemplary of the principals of the invention and is not intended to limit the invention to the embodiments and the specific examples illustrated and the invention is not to be limited to the details given herein, but may be modified within the scope and equivalents of the descriptions and examples contained herein.

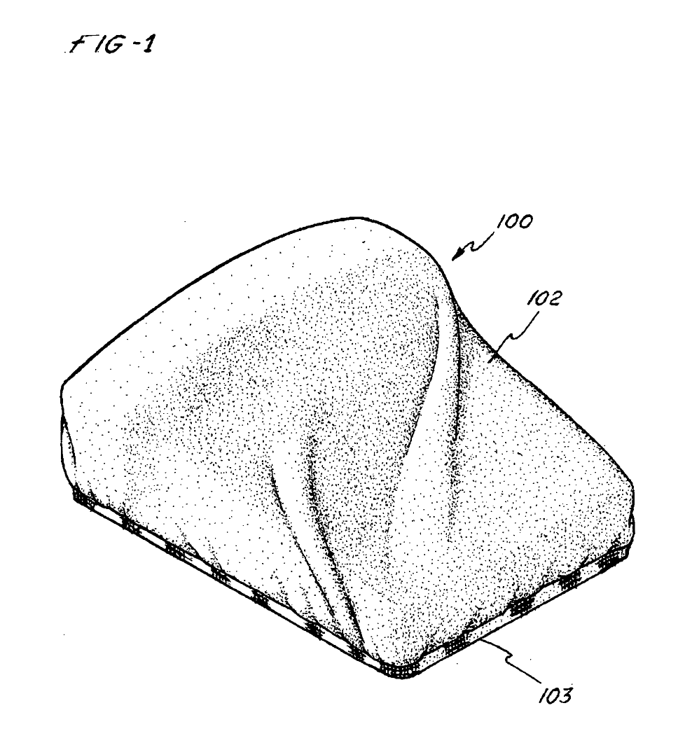

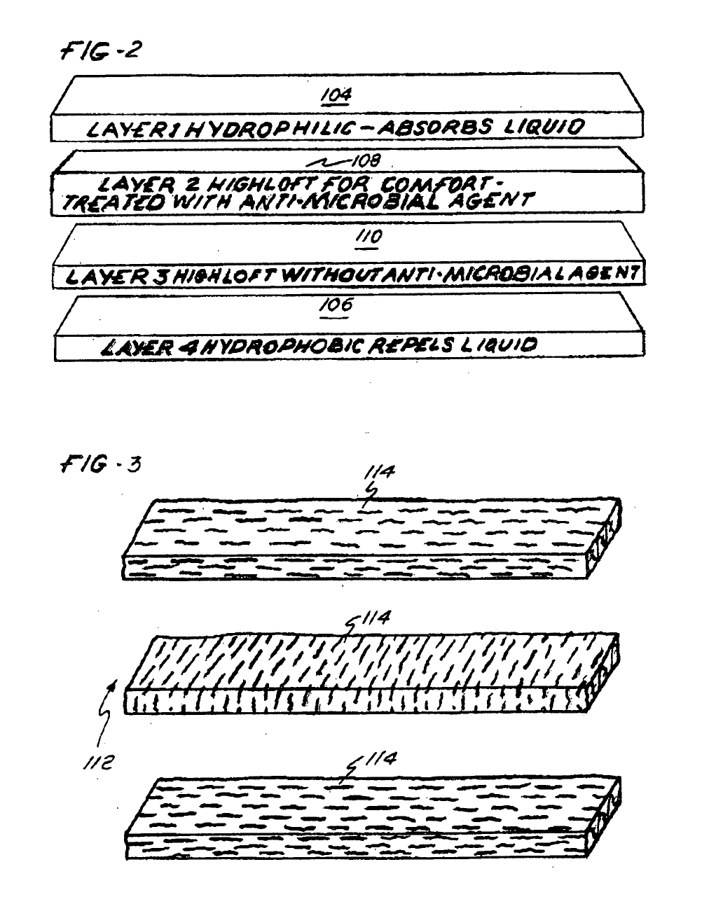

Referring to FIG. 1, in a preferred embodiment of the invention, the sanitary cover 100 of the present invention is shown comprising a fabric material 102 having an attachment means 103. Preferably, the fabric material 102 is formed from a single layer, such as shown in FIG. 1, or a plurality of layers or sheets of material, such as represented in FIG. 2. The inner layer 104 is preferably formed from a soft hydrophilic material while the outer layer 106 is preferably formed from a hydrophobic material. A variety of such hydrophilic materials are well known. The middle layer 108 or layers is relatively porous such that it is effective for providing a substrate for supporting a germicide, bactericide or an antiviral agent or a combination thereof. A variety of such materials effective for providing a substrate for supporting such agents are well known. In addition, a middle layer 110 may also be provided for providing padding, for example cotton, for extra comfort. The attachment means 103 can comprise various means including an elastic band or collar, mechanical attachment means, releasable adhesives, and means commonly referred to static-cling.

Referring to FIGS. 1 and 3, in another preferred embodiment of the invention the fabric material 102 is shown formed from a plurality of layers 112. As shown, each layer 112 is formed having a specific porosity pattern 114 having a specific orientation. The layers 112 are then placed one upon the other such that the orientation of one layer is slightly different than the orientation of the previous layer thereby forming a labyrinth that is effective for reducing or eliminating the passage of all or some types of contamination, such as germs, bacteria, viruses, dirt, dust, and the like. It should be understood that other labyrinth layer systems, such as an open pore systems that reduces or eliminates all or some contamination, may also be used. Preferably, for certain applications, such as for protection masks, the fabric material should be effective for eliminating or reducing certain types of contamination from migrating through the fabric material while permitting the free flow of air there through. For an example, the fabric material may be a needle-punched fabric produced from a blend of fibers. Preferably, the fabric material may be constructed in layers, such as shown in FIG. 2, having an inner layer that for contacting the contact surfaces of the article being covered. One example of a suitable fabric material is formed from a resin-bonded polyester. In another preferred embodiment of the invention the fabric material has an outer layer of entirely made water proof, such as for example, by the inclusion of a paraffin based emulsion which is incorporated into the binder mix forming about 0.5% to about 1% of the total fabric weight.

It should now be apparent to those skilled in the art that the sanitary cover may also be made in a variety of colors depending on the aesthetic desires of the user. It should also now be apparent to those skilled in the art that the cover as described would be inexpensive enough to be disposable, but could be cleaned and reused if desired. Further, in another preferred embodiment of the invention, the sanitary cover can include a freshness indicator, such as a color changing indicator that reacts to being exposed to air, liquid, light, and the like. The indicator would operate that after being exposed to air for a certain period of time or to a liquid, or light, the color of the indicator would change indicating the sanitary cover should be replaced. Such exposure indicators reacting to air and liquids are well known.

For use with acoustical devices such as microphones, telephones, earphones, headsets, and other sound transmitting devices, the fabric material forming the sanitary cover is preferably formed using an acoustically-transparent material or a material that minimizes acoustic distortion there through, such as for example, the material described hereinabove.

In a preferred embodiment of the invention, the fabric material forming the sanitary cover is treated with or is provided with a layer having a germicide agent, such as a bactericide agent or an antiviral agent, that are effective for eliminating or reducing germs such as bacteria or viruses from penetrating or migrating through the sanitary cover. Such germicide agents may include a naturally microbe-killing/preventing metal, for example a silver included fiber. Preferably, about 10% to about 60% of the weight of the fiber material will include an inert anti-microbial type fiber, such as sold under the trademark ALPHA-SAN by Milliken.

The invention can be better understood by reference to the following illustrative examples of the preferred embodiments of the invention. It should be understood that the examples are meant to illustrate the invention and not to limit the scope of the invention in any way.

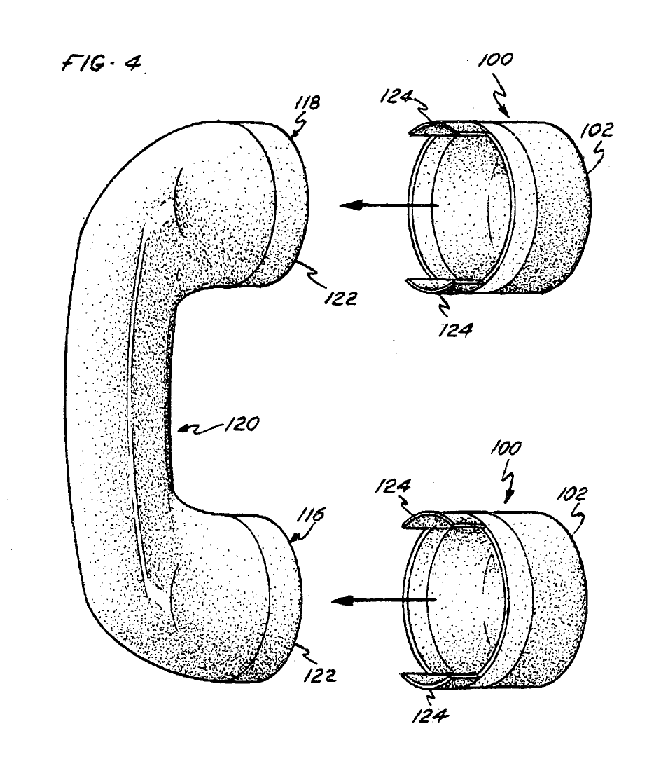

In a preferred embodiment of the sanitary cover of the present invention is shown, the cover is configured for covering the contact surfaces of various electrical devices such as microphones, telephones, earphones, headsets, hand sets, recoding and acoustical playing devices, and the like. For illustrated purposes, as shown in FIG. 4, the sanitary cover 100 is shown configured for attachment to a mouthpiece 116 and the ear piece 118 of a conventional telephone hand piece 120. As shown, the sanitary cover 100 attaches to the mouthpiece 116 and ear piece 118 such that the contact surfaces 122 are covered. While FIG. 4 shows a pair of sanitary covers 100 covering the mouthpiece 116 and the ear piece 118 of the telephone hand piece 120, it should be understood, however, that a single cover 100 could be adapted to cover the entire contact surfaces 122 of the telephone hand piece 120. In a preferred embodiment of the invention, the attachment means 103 is formed from an elastic band (FIG. 1) that can be used by stretching the band over the portion of the device to be covered. In a preferred embodiment of the invention, the attachment means 103 is shown (FIG. 4) comprising a pair of oppositely disposed tabs 124 on the perimeter of the fabric material 102 to allow the user to be placed onto the respective mouth piece 116 or ear piece 118 without having to touch the fabric material 102 of the sanitary cover 100.

In another illustration of the many uses of the sanitary cover of the present invention, as shown in FIG. 5, the sanitary cover 100 is configured, such as being elongated, for attachment to the mouth piece 126 of a conventional speaker 128, such as used with a headset (as shown) or a stand along speaker (Not shown). As illustrated, the sanitary cover 100 is adapted for covering the entire contact surface of the mouth piece 126. In a preferred embodiment of the invention, the attachment means 103 is formed from an elastic band (FIG. 1) that can be used by stretching the band over the portion of the device to be covered. In a preferred embodiment of the invention, the attachment means 103 is shown (FIG. 5) comprising a pair of oppositely disposed tabs 124 on the perimeter of the fabric material 102 to allow the user to be placed onto the mouth piece 126 without having to touch the fabric material 102 of the sanitary cover 100.

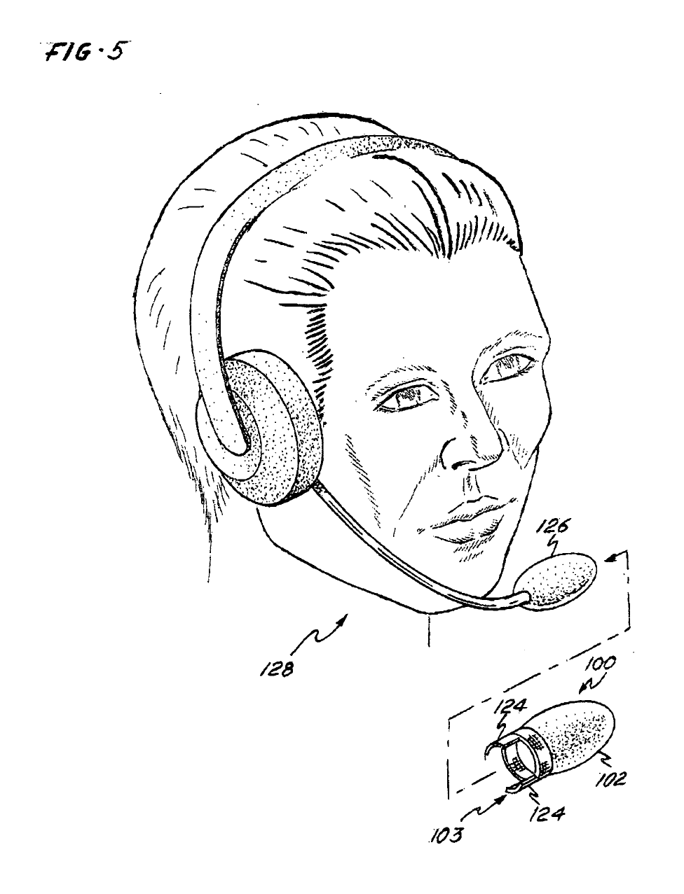

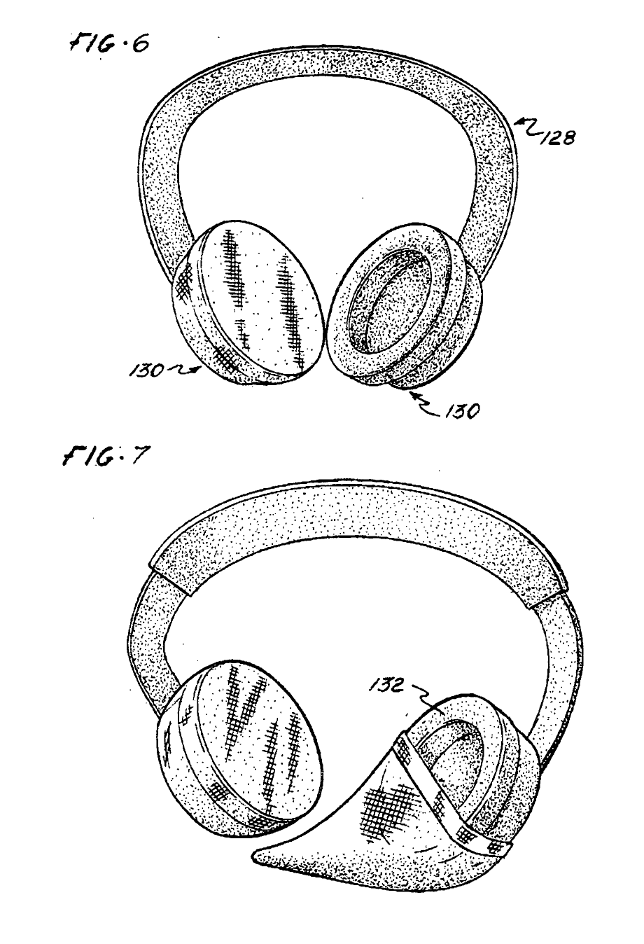

In another illustration, shown in FIGS. 6 and 7, a conventional acoustic headphone 128 is shown having a pair of ear pieces 130. As shown, in a preferred embodiment of the present invention, the sanitary cover 100 is configured for attachment to the ear pieces 130 of the conventional headphone 128 by slipping the cover over the entire ear piece 130 to cover the entire contact surface 132 of the ear pieces 130. In another embodiment of the invention (not shown), the sanitary cover 100 includes an inner layer 108 (FIG. 2) of padding material for providing extra comfort to the headphone 128.

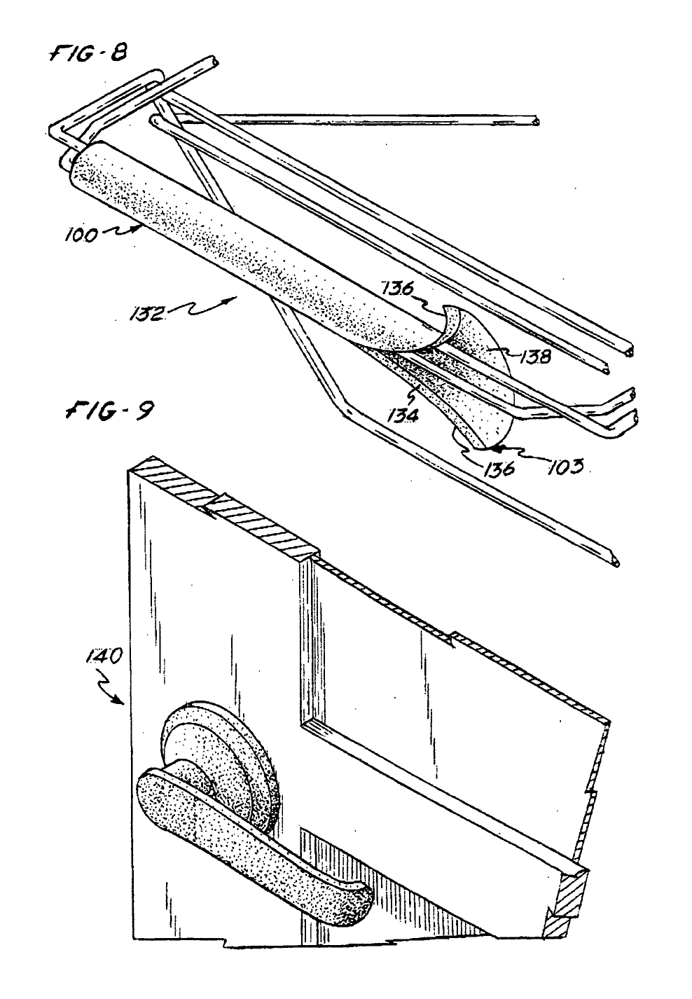

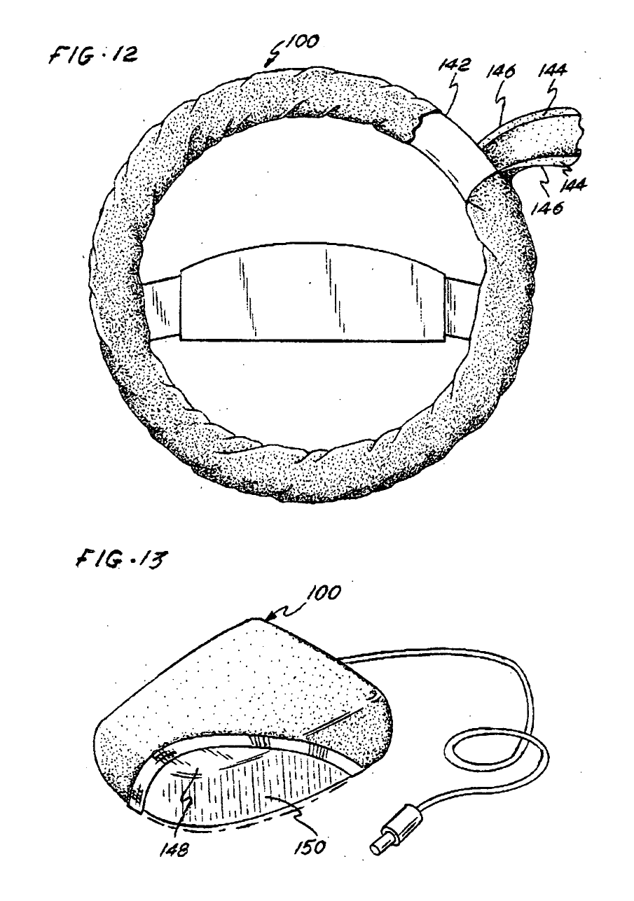

In another illustration, the sanitary cover is configured for covering the contact surfaces found on various apparatus such as handles (FIG. 8), knobs (FIGS. 9, 10 and 11), steering wheels (FIG. 12), computer equipment (FIG. 13), and the like.

As shown in FIG. 8 a conventional handle 132, like a grocery cart handle, is covered by another preferred embodiment of the present invention. The sanitary cover 100 is formed in an elongated shape and is provided with an attachment means 103 for attaching to the handle 132. In a preferred embodiment of the invention, the attachment means 103 comprises an elongated strip 134 comprising a conventional releasable adhesive effective for securing the ends 136 of the sanitary cover 100 together. In another embodiment of the invention, not shown, the entire inner surface 138 or a portion of the inner surface 138 is coated with a conventional releasable adhesive. In another preferred embodiment of the invention, the attachment means comprises the inner surface 138 being formed from a material know as “static cling” material that maintains the sanitary cover 100 in position on the handle 132.

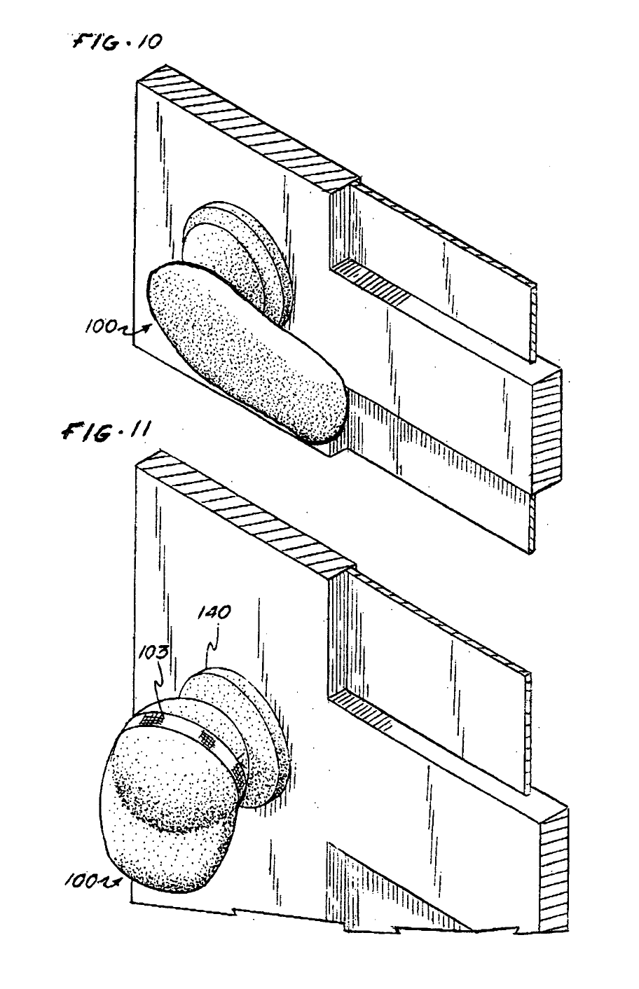

Referring to FIGS. 9, 10 and 11, another illustration of the sanitary cover 100 of the invention is shown whereby another form of a handle or knob 140 is shown (FIG. 9). FIG. 11 is another illustration of a knob 140 having a different shape or configuration covered by the sanitary cover 100. The handle or knob 140 is easily covered with the sanitary cover 100 (FIGS. 10 and 11) and held in place by the attachment means 103 (FIG. 11). In the embodiment shown, the attachment means comprises an elastic band.

Referring to FIG. 12, another illustration of the sanitary cover 100 of the invention is shown whereby the cover 100 is formed in a elongated circular form that wraps around the article 142, such as an automotive steering wheel. In a preferred embodiment of the invention, the attachment means 103 is formed from a releasable adhesive 144 applied along the edges 146 of the sanitary cover 100.

Referring to FIG. 13, another illustration of the sanitary cover 100 of the invention is shown whereby the cover 100 is placed over the contact surface 148 of an electrical device 150, such as a computer mouse of a conventional home computer.

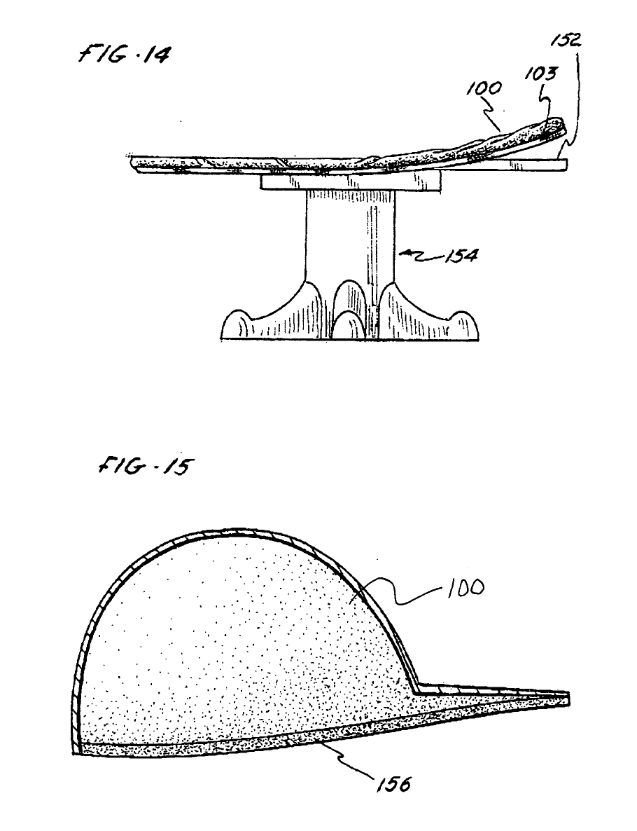

Referring to FIG. 14, another illustration of the sanitary cover 100 of the present invention is shown. The cover 100 is configured and sized for covering the contact surfaces 152 for various articles 154 having larger contact surfaces 152, such as table tops (as shown), trays, and the like. For illustrated purposes, the cover 100 is shown attached to an article 154, such as a table, in such a manner that the sanitary cover 100 covers the entire top surface of the table and held in place by an attachment means 103 comprising an elastic band.

Referring to FIG. 15, another illustration of the sanitary cover 100 of the present invention is shown. The cover 100 is configured and sized for use as an inner liner for an article 156, such as a hat, helmet, hard hat, or the like.

It should be understood that the specific attachment means of the sanitary cover of the present invention can be selected from various means suitable for attaching to the particular device or apparatus. For example, the selected attachment means may be a mechanical means, such as a push tab or an elastic band. The selected attachment means may also be selected comprising means comprising materials known as static cling material, or formed from a variety of adhesives know as release adhesives that operate to releasable attach the sanitary cover to a surface and allows the cover to be easily removed without leaving a residue on the surface of the object.

It should now be understood to those skilled in the art that the particular sanitary cover configuration is dependent on the particular contact surface to be covered. For example, for use with acoustical devices, such as microphones, telephones, earphones, headsets, and other sound transmitting devices, the fabric material forming the sanitary cover is preferably an acoustically-transparent material or a material that minimizes acoustic distortion there through and is effective for reducing or preventing the spread of contamination such as germs, bacteria, viruses, dirt, dust, and the like. For use with headphones, head sets, and the like, the cover may include padding for providing added comfort for the wearer. In another illustrative example, the sanitary cover for use to cover table tops is preferably is formed from a liquid impermeable fabric that is also effective for reducing or preventing the spread of contamination such as germs, virus, and the like. In another illustrative example, the sanitary cover for use with a breathing or protective mask is preferably formed from a fabric that is effective for reducing or preventing the spread of contamination such as germs, virus, and the like, prevents or reduces other contamination, such as dust and dirt, from passing or migrating there through while permitting the free flow of air. In another illustrative example, the sanitary cover for use to cover steering wheels, handles, knobs, and the like, preferably is formed from a fabric material is also effective for reducing or preventing the spread of contamination such as germs, virus, and the like and includes a lotion, powder, or the like for added comfort to the user. In another illustrative example, the sanitary cover for use in covering the contact surface of tables, trays, and the like, preferably is formed from a fabric material is effective for reducing or preventing the spread of contamination such as germs, virus, and the like, and is formed from a liquid impermeable fabric. It should also now be apparent that the sanitary cover could also be provided with a lotion, such as an aloe, within the fibers of the fabric material for added comfort during use. The sanitary cover may also be provided with a freshness indicator to allow the user to know how fresh the sanitary cover is and if the cover needs to be replaced.

Although the foregoing invention has been described in some detail for purposes of clarity of understandings, it will be apparent that certain changes and modifications may be practiced within the scope of the appended claims. Furthermore, it should be noted that there are alternative ways of implementing the method of the present invention. Accordingly, it should be understood that the present disclosure is to be considered as exemplary of the principals of the invention and is not intended to limit the invention to the embodiments illustrated and the invention is not to be limited to the details given herein, but may be modified within the scope and equivalents of the appended claims.

1. A sanitary cover for use in covering a surface area of an article, the sanitary cover comprising:
a fabric material; and
means for attaching the sanitary cover to the article;
wherein said fabric material comprises an inner layer formed from a hydrophilic material and an outer layer formed from a hydrophobic material.

2. The sanitary cover of claim 1 wherein said fabric material comprises at least one middle layer formed from a porous material effective for supporting a germicide, bactericide, an antiviral agent, or a combination thereof.

3. The sanitary cover of claim 1 wherein said fabric material comprises at least one middle layer formed from a padding material.

4. The sanitary cover of claim 1 wherein said fabric material comprises a plurality of layers forming a labyrinth effective for reducing the passage of contaminates there through.

5. The sanitary cover of claim 1 wherein said fabric material is formed from an elastomeric polymer.

6. The sanitary cover of claim 1 is formed from a spun lace elastomeric material.

7. The sanitary cover of claim 1 is formed from a substantially acoustically transparent material.

8. The sanitary cover of claim 1 is formed from a liquid impermeable fabric.

9. The sanitary cover of claim 1 is formed from a fabric includes a lotion contained therein.

10. The sanitary cover of claim 1 further comprising means for indicating the freshness of the cover.

11. The sanitary cover of claim 1 wherein said means for attaching the sanitary cover to the article comprises a mechanical means.

12. The sanitary cover of claim 1 wherein said means for attaching the sanitary cover to the article comprises an adhesive means.

13. The sanitary cover of claim 1 wherein said means for attaching the sanitary cover to the article comprises a static-cling material.

14. A sanitary cover for use in covering a surface area of an article, the sanitary cover comprising:
a fabric material; and
means for attaching the sanitary cover to the article;
wherein said fabric material comprises an inner layer formed from a hydrophilic material and an outer layer formed from a hydrophobic material and at least one middle layer effective for reducing the passage of various types of contamination.

15. A sanitary cover of claim 14 wherein said sanitary cover includes at least one agent from the group consisting of germicides, bactericides, antiviral agents, and a combination thereof.

16. The sanitary cover of claim 14 wherein said fabric material comprises a plurality of layers forming a labyrinth effective for reducing the passage of contaminates there through.

17. The sanitary cover of claim 14 wherein said middle layer forms a labyrinth effective for reducing the passage of contaminates.

18. The sanitary cover of claim 14 wherein said means for attaching the sanitary cover to the article is selected from the group consisting of mechanical means, releasable adhesives, and static-cling materials.

19. The sanitary cover of claim 14 is formed from a fabric includes a lotion contained therein.

20. The sanitary cover of claim 15 further comprising means for indicating the freshness of the cover.
